(19) United States
(12) Patent Application Publication
(10) Pub. No.: US 2017/0041992 A1
(43) Pub. Date: Feb. 9, 2017

(54) LIGHT SOURCE DRIVING DEVICE AND DIMMING/TONING CONTROL METHOD

(71) Applicant: MINEBEA CO., LTD., KITASAKU-GUN (JP)

(72) Inventors: Kosuke SUMI, FUKUROI-SHI (JP); Kohei NISHIBORI, IWATA-SHI (JP); Kunihiko HATTA, YOKOHAMA-SHI (JP); Yosuke ODA, FUKUROI-SHI (JP)

(21) Appl. No.: 15/226,514

(22) Filed: Aug. 2, 2016

(30) Foreign Application Priority Data
Aug. 4, 2015 (JP) 2015-154503

(51) Int. Cl. H05B 33/08

(52) U.S. Cl. CPC H05B 33/086; H05B 33/0845

(57) ABSTRACT

A light source driving device including: a dimming/toning controller that receives a dimming indication signal and a toning indication signal for driving a plurality of light sources and calculates control information of each of the light sources based on the diming indication signal and the toning indication signal; and a plurality of driving circuits that respectively drives each of the light sources according to each of the control information calculated by the dimming/toning controller.

### BACKGROUND OF THE DISCLOSURE

1. Field of the Invention

The present invention relates to a light source driving device and a dimming/toning control method.

2. Description of the Related Art

For example, in a light source driving device of a related-art illumination device, a controller is configured to control each light source based on information which is stored in advance in a memory table, which corresponds to control level of each light source. Therefore, as the number of control levels becomes larger, the data amount of required memory table is increased. That is, when the number of control levels becomes larger, the required memory area has been forced to increase.

Meanwhile, as disclosed in IEC 62386-102, “INTERNATIONAL STANDARD NORME INTERNATIONALE-IEC”, ISBN 978-2-88910-687-5, p1 to 139, 2009, with the revision of recent DALI standard, there is a tendency to be increased in the number of dimming and toning levels that is controllable in the standard. In addition, there is a tendency to be increased largely in the number of dimming and toning levels for the purpose of good illumination.

However, as described above, when the number of control levels becomes larger, the required memory area is enlarged. Further, there is a problem that cost of a controller (a micro computer) including a memory is increased.

### SUMMARY OF THE INVENTION

One of objects of the present invention is to provide a light source driving device and a dimming/toning control method which are capable of reducing a cost of a memory or a controller (microcomputer) even when the number of control levels becomes larger.

According to an illustrative embodiment of the present invention, there is provided a light source driving device including: a dimming/toning controller that receives a dimming indication signal and a toning indication signal for driving a plurality of light sources and calculates control information of each of the light sources based on the diming indication signal and the toning indication signal; and a plurality of driving circuits that respectively drives each of the light sources according to each of the control information calculated by the dimming/toning controller.

According to another illustrative embodiment of the present invention, there is provided a diming/toning control method to be executed by a light source driving device for driving a plurality of light sources, the method including: receiving a dimming indication signal and a toning indication signal for driving a plurality of light sources; calculating control information of each of the light sources based on the diming indication signal and the toning indication signal; and driving each of the light sources according to each of the control information calculated by the dimming/toning controller.

### BRIEF DESCRIPTION OF THE DRAWINGS

In the accompanying drawings:

FIG. 1 is a configuration diagram illustrating a schematic system of a light source driving device according to the embodiment;

FIG. 2 is a graph illustrating a relationship between a LED light intensity and a duty value converted by a microcomputer of a light source driving device according to the embodiment;

FIGS. 3A and 3B are flowcharts illustrating a dimming/toning control method of a light source driving device according to the embodiment;

FIGS. 4A to 4D are diagrams illustrating a state of PWM dimming of a light source driving device according to the embodiment;

FIG. 5 is a configuration diagram illustrating a schematic system of a light source driving device according to Comparative Example;

FIG. 6 is a diagram illustrating a memory table of a light source driving device according to Comparative Example; and

FIG. 7 is a flowchart illustrating a dimming/toning control method of a light source driving device according to Comparative Example.

### DETAILED DESCRIPTION

Hereinafter, an embodiment of the invention will be described in detail with reference to each of drawings. First, Comparative Example will be described before the description of the embodiment.

### Comparative Example

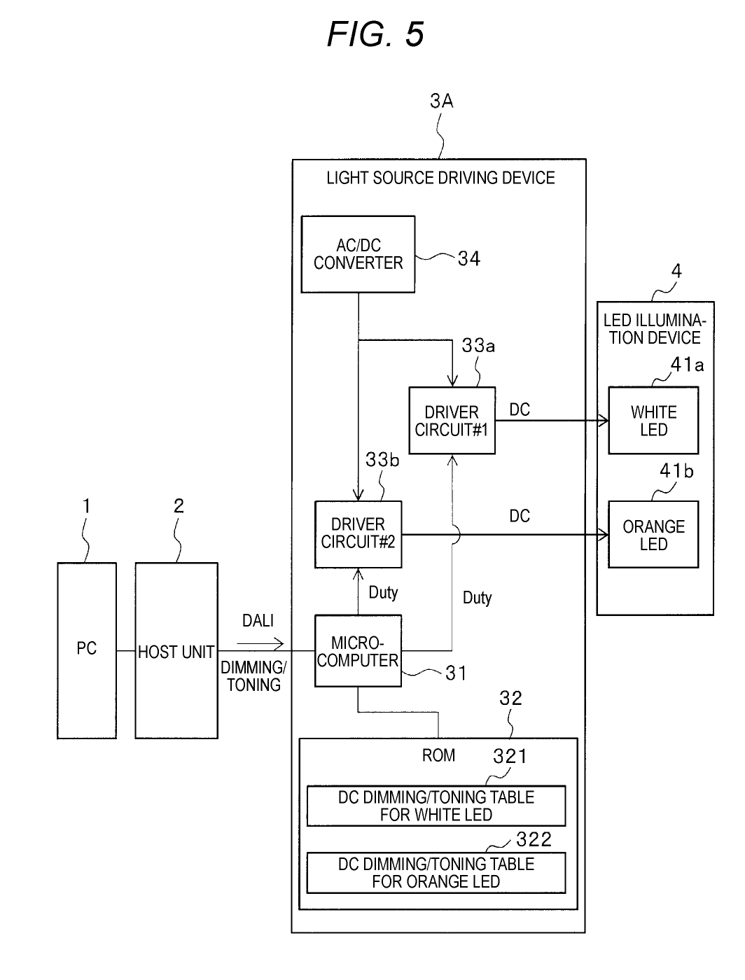

FIG. 5 is a configuration diagram of a schematic system of an illumination device including a light source driving device 3A according to Comparative Example.

The illumination device according to Comparative Example is configured to include a personal computer 1 (illustrated as PC1 in the drawings) which also serves as a user interface, a host unit 2 of converting a dimming/toning indication signal received from the personal computer 1 to a dimming/toning indication signal of DALI (trademark: Digital Addressable Lighting Interface), for example, and outputting the converted signal, a light source driving device 3A, and an LED illumination device 4.

The host unit 2 may output a dimming/toning indication signal of ECHONET Lite (registered trademark) other than the DALI (registered trademark), for example.

The personal computer 1, for example, includes a display of a touch panel type, and may include a function as a controller such as a function of a general PWM (Pulse Width Modulation) dimmer. For example, the personal computer may include a function that displays a pivotal dial and an on-off switch (not illustrated) on the display and accepts user's selection. The personal computer 1 outputs the dimming/toning information to the host unit 2 based on a position index of the dial, for example.

The host unit 2 converts the dimming/toning indication signal input from the personal computer 1 to a dimming/toning indication signal of the DALI (registered trademark), for example, and outputs the converted signal to the light source driving device 3A. The dimming/toning indication signal may be converted to a dimming/toning indication signal of other method and the converted signal may be output to the light source driver 3A.

The light source driving device 3A includes a ROM 32 which is a storage unit, a microcomputer 31, a driver circuit 33a serving as a first lighting circuit (a driving circuit), and a driver circuit 33b serving as a second lighting circuit (a driving circuit).

The ROM 32, which is for example a Read Only Memory, stores a dimming/toning memory table. More specifically, for example, a DC dimming/toning table 321 for a white LED and a DC dimming/toning table 322 for an orange LED are stored (described below in detail). A predetermined duty is stored in the DC dimming/toning table 321 for a white LED and the DC dimming/toning table 322 for an orange LED.

The microcomputer 31 reads out the stored duty by referring to the dimming/toning memory table stored in the ROM 32 based on the dimming/toning indication signal of the DALI which is input from the host unit 2, for example. Then, the duty, which is read out from the DC dimming/toning table 321 for a white LED, is output to the driver circuit 33a. In the same manner, the duty, which is read out from the DC dimming/toning table 322 for an orange LED, is output to the driver circuit 33b. Thus, it is possible to perform the dimming/toning by driving a plurality of LEDs, which have different emission color, using each suitable duty.

The driver circuit 33a serving as the first lighting circuit is connected to a white LED 41a which is a first light source of the LED illumination device 4. The driver circuit 33a drives the white LED 41a using a current which is according to the duty of the DC dimming/toning table 321 for a white LED. In the same manner, the driver circuit 33b serving as the second lighting circuit is connected to an orange LED 41b which is a second light source of the LED illumination device 4. The driver circuit 33b drives the orange LED 41b using a current which is according to the duty of the DC dimming/toning table 322 for an orange LED.

The electrical power is supplied to the driver circuit 33a and the driver circuit 33b from an AC/DC converter 34 which is a power supply.

The LED illumination device 4 includes two light sources which are different from each other color temperature: a white LED 41a as a first light source and an orange LED 41b as a second light source. The LED illumination device 4 may include a light source having at least two different color temperatures, and the number and the illumination color are not limited particularly to this example.

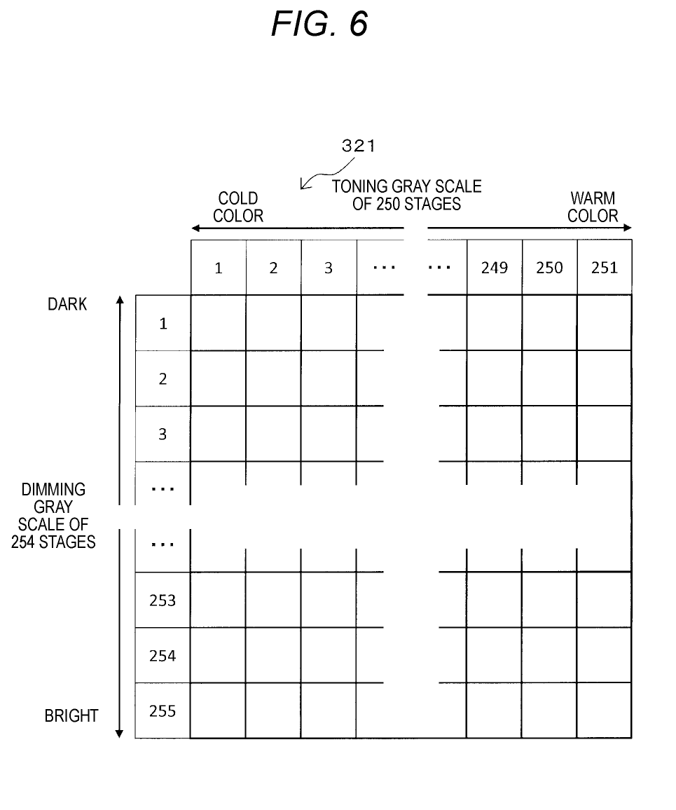

FIG. 6 is a diagram illustrating a memory table of a light source driving device 3A according to Comparative Example. In FIG. 6, the DC dimming/toning table 321 for a white LED will be described as an example of a dimming/toning memory table, but the DC dimming/toning table 322 for an orange LED also has the same configuration.

As illustrated in FIG. 6, the dimming/toning indication signal of the DALI (registered trademark), which is input to the light source driving device 3A from the host unit 2, has the number of control levels including toning levels of 250 stages (record 1 (coldest color) to record 251 (warmest color)) and dimming control levels of 254 stages (record 1 (darkest) to record 255 (brightest)). In other words, the DC dimming/toning table 321 for a white LED has storage areas with 251*255=64,005. In the DC dimming/toning table 321 for a white LED, the duty corresponding to each control level, in other words, the duty for performing a PWM dimming control by driving the driver circuit 33a in correspondence with each control level is stored.

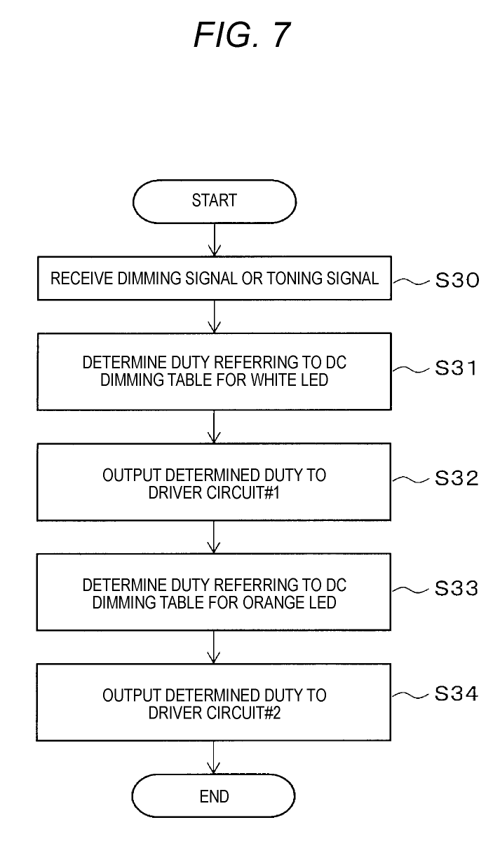

Next, referring to FIG. 7, a flowchart of a dimming/toning control method of a light source driving device 3A according to Comparative Example will be described.

In step S30, the microcomputer 31 of the light source driving device 3A receives the dimming signal or the toning signal according to the DALI (registered trademark) from the host unit 2, for example.

Next, in step S31, the microcomputer 31 refers to the DC dimming/toning table 321 for a white LED. Then, the microcomputer determines (specifies) the duty, which is stored in the table with the number of control level, based on the dimming signal or the toning signal received in step S30.

In step S32, the microcomputer 31 outputs the duty determined in step S31 to the first driver circuit 33a.

Then, in step S33, the microcomputer 31 refers to the DC dimming/toning table 322 for an orange LED. Then, the microcomputer determines (specifies) the duty, which is stored in the table with the number of control levels, based on the dimming signal or the toning signal received in step S30.

In step S34, the microcomputer 31 outputs the duty determined in step S33 to the second driver circuit 33b, and the present flow ends.

### Embodiment

Hereinafter, the embodiment of the invention will be described in detail, focusing on the particular different parts compared to Comparative Example described above, while comparing with Comparative Example.

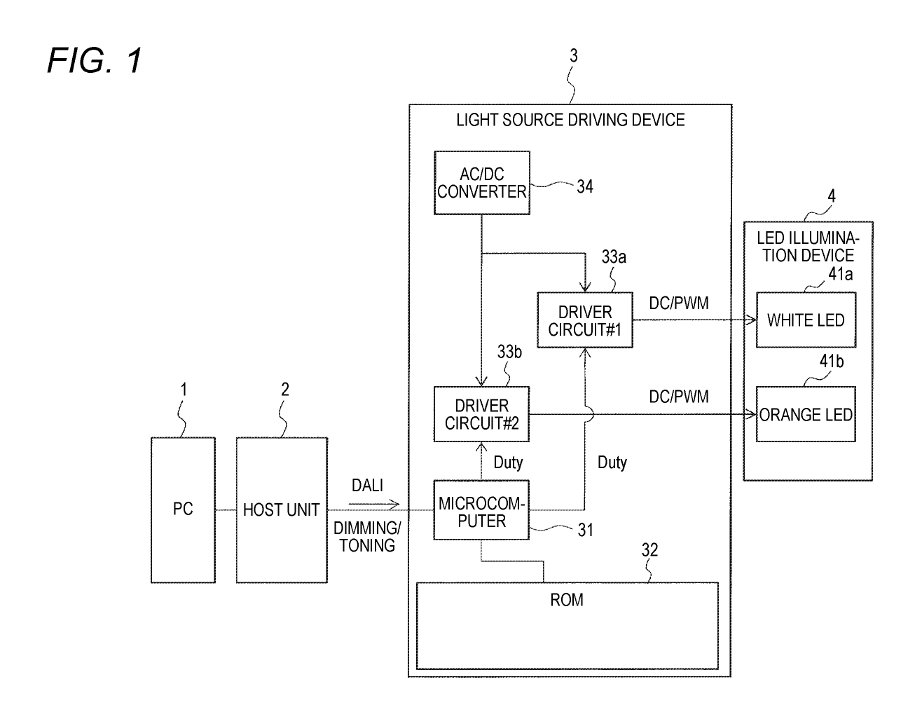

FIG. 1 is a configuration diagram illustrating the schematic system of the light source driving device 3 according to the embodiment. The light source driving device 3 of the present embodiment is different from the light source driving device 3A according to Comparative Example illustrated in FIG. 5, in that the dimming/toning memory table is not stored in the ROM 32 which is a memory. Specifically, there is a difference that the DC dimming/toning table 321 for a white LED and the DC dimming/toning table 322 for an orange LED are not stored in the ROM 32. The other configuration is the same as the light source driving device 3A according to Comparative Example.

According to such a configuration, for example, although the number of control levels of the dimming/toning indication signal according to DALI (registered trademark), which is input to the microcomputer 31 from the host unit 2, is increased, the memory area of the ROM 22 is not enlarged. In other words, it is possible to achieve a cost reduction of the light source driving device 3 and, in particular, the microcomputer 31.

Although the details will be described below, the microcomputer 31 of the light source driving device 3 according to the present embodiment calculates and generates a control amount corresponding to each control level by calculation using a ratio calculation equation for a previously prepared dimming control and toning control. Then, the microcomputer 31 converts the calculated control amount into a duty, and appropriately outputs the duty to the driver circuit 33a and/or the driver circuit 33b.

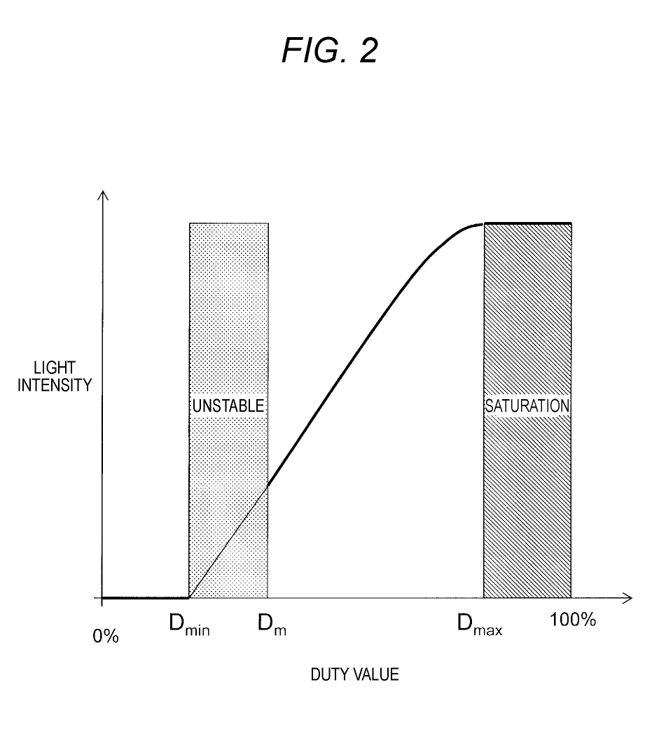

FIG. 2 is a graph illustrating a relationship between the duty value, which is calculated and converted by the microcomputer 31 of the light source driving device 3 according to the embodiment, and the LED light intensity of the LED illumination device 4.

As illustrated in FIG. 2, in the LED illumination device 4 according to the embodiment of the invention, the duty value can be divided into a region of 0% to Dmin, a region of Dmin to Dm, a region of Dm to Dmax, and a region of Dmax to 100%.

First, the region where the duty value is 0% to Dmin is a region where the light intensity becomes 0, regardless of the value of the duty value.

Next, the region where the duty value is Dmin to Dm is a region where the light intensity becomes unstable. Here, Dmin represents the duty of a minimum value when the LED illumination device 4 emits light. Moreover, Dm represents the duty of a minimum value when the LED illumination device 4 stably emits light.

Next, the region where the duty value is Dm to Dmax is a region where the light with stable light intensity is emitted and the light intensity is increased gradually as the duty value is increased gradually. In other words, the region where the duty value is Dm to Dmax is a region having a substantially linear relationship (substantially linear curve) between the duty value and the light intensity.

Finally, the region where the duty value is Dmax to 100% is a region where the light intensity is in a saturation state and is not increased even when the duty value is increased.

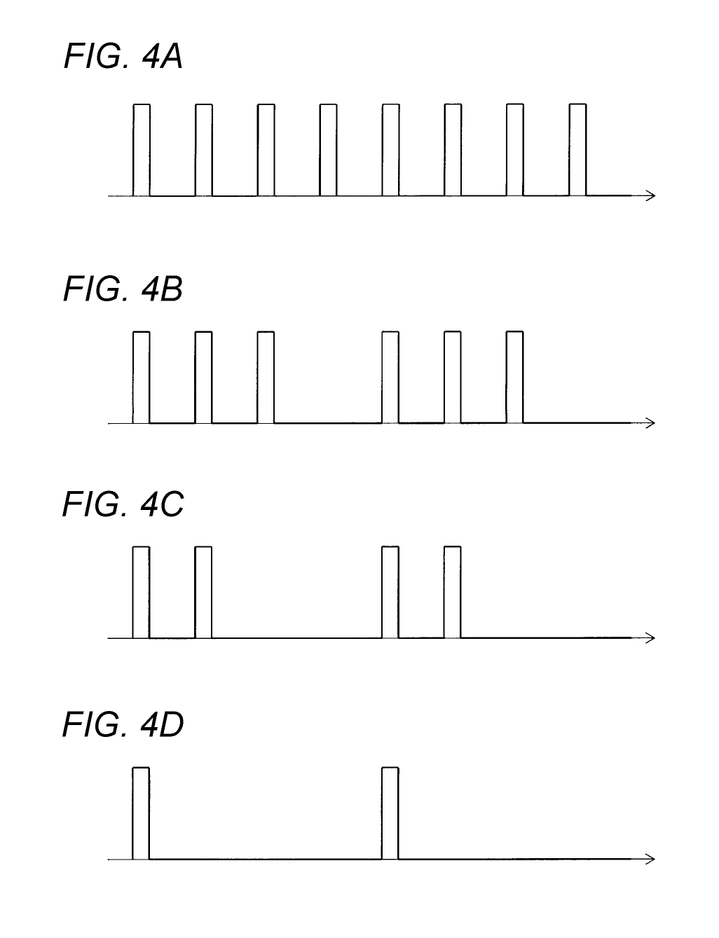

According to the above description, in order to obtain an effective light intensity of the LED illumination device 4, it is desirable that the duty value is a value between Dmin and Dmax (Dmin≦duty value≦Dmax). In particular, in the unstable region (Dmin≦duty value≦Dm), it is desirable to output the duty having a predetermined value to the driver circuit periodically at a predetermined ratio (described in detail below in FIG. 4).

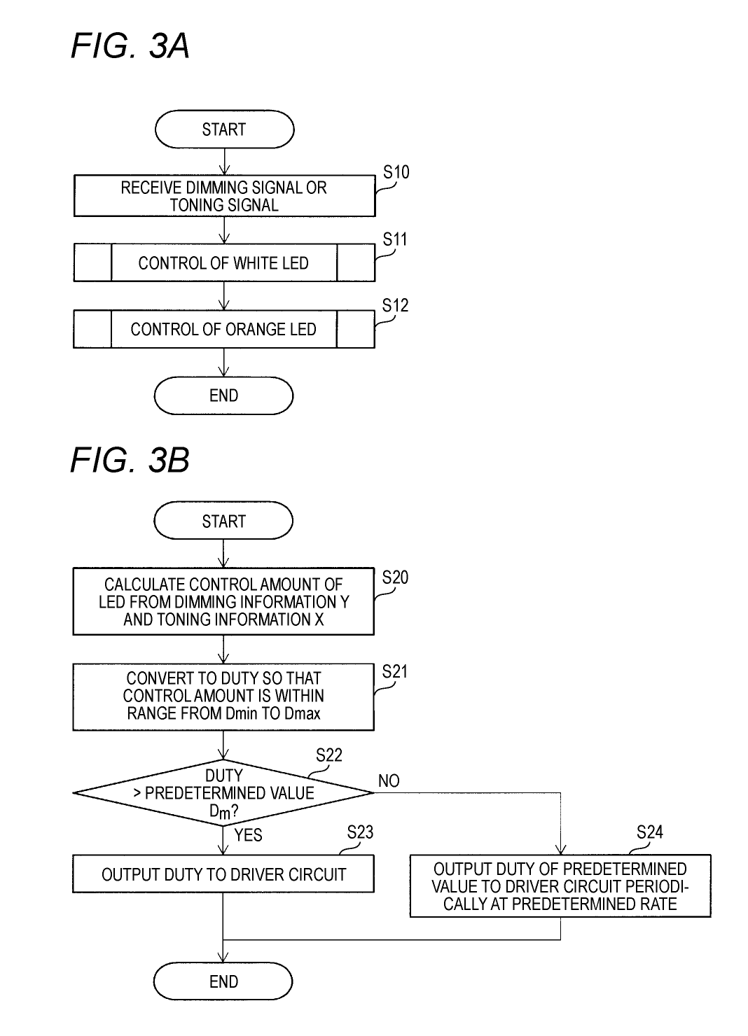

Next, FIGS. 3A and 3B are a flowchart illustrating a dimming/toning control method of the light source driving device 3 according to the embodiment.

First, referring to FIG. 3A, the schematic dimming/toning control method of the light source driving device 3 according to the embodiment will be described.

In step S10, the microcomputer 31 of the light source driving device 3 receives the dimming signal or the toning signal from the host unit 2.

Next, the light source driving device 3 controls the white LED 41a in step S11.

Then, in step S12, the light source driving device 3 controls the orange LED 41b, the present flow ends.

Next, referring to FIG. 3B, a detailed dimming/toning control method of the light source driving device 3 according to the embodiment will be described. FIG. 3B illustrates the specific processing contents of the control of the white LED 41a of step S11 in FIG. 3A, for example. The control of the orange LED 41b in step S12 can be considered in the same manner as in FIG. 3B.

First, in step S20, the microcomputer 31 of the light source driving device 3 calculates a control amount for causing the LED (specifically the white LED 41a) to emit light, based on the dimming information Y and toning information X received from the host unit 2. Here, a content of the control amount is not particularly limited. In the present embodiment, the control amount is a parameter that the duty for performing the PWM control can be directly or indirectly calculated, for example.

Specifically, for example, the microcomputer 31 (the dimming/toning controller) divides proportionally the control amount, which is based on the dimming information Y according to the dimming indication signal, into each light source by multiplying a ratio based on the toning information X corresponding to the value of toning indication signal, and sets the calculated value to the control amount for causing the white LED 41a to emit light (the same applies to the orange LED 41b).

For example, according to the diming indication signal, a dimming factor is calculated by dividing a value based on the dimming information Y by a value based on the number of the dimming control level. Then, according to the toning indication signal, a toning factor is calculated by dividing and prorating a value based on the toning information X for each light source by a value based on the number of toning levels. Then, the calculated value, which is obtained by multiplying the ratio of the dimming factor and the toning factor for each light source, may be used as the control amount of the light source.

Next, in step S21, the microcomputer 31 performs conversion to the duty for performing the PWM control of the white LED 41a so that the control amount calculated in step S20 is to be a control amount between Dmin and Dmax illustrated in FIG. 2. The Dmin and Dmax described above are a minimum value and a maximum value of the duty for effectively obtaining the light intensity of the LED illumination device 4 without excess and deficiency, respectively.

At this time, the microcomputer 31 may calculate control information of the LED illumination device 4, which is a light source, by performing linear conversion so that the control amount is to be a control amount between the maximum control amount and the minimum control amount of each driving circuit. The microcomputer 31 may calculate the control information of the LED illumination device 4, which is a light source, by performing conversion with a log curve so that each control amount is to be a control amount between the maximum control amount and the minimum control amount of each driving circuit.

Then, in step S22, the microcomputer 31 determines whether or not the duty converted in step S21 is greater than the Dm, in other words, the duty of a predetermined minimum value when the LED illumination device 4 described above in FIG. 2 stably emits light (duty>Dm).

In a case where “Yes” is determined in step S22, in other words, the duty converted in step S21 is greater than the Dm, the LED illumination device 4 can emit light stably as described in FIG. 2 even when outputting the duty as it is to the driver circuit 33a.

Therefore, in step S23, the microcomputer 31 outputs the duty as it is to the driver circuit 33a, and the present control flow ends.

In a case where “No” is determined in step S22, in other words, the duty converted in step S21 is smaller than Dm, the light emission of the LED illumination device 4 becomes unstable as described in FIG. 2 when outputting the duty as it is to the driver circuit 33a.

Therefore, in step S24, the microcomputer 31 does not output the duty as it is to the driver circuit 33a, and outputs the duty of the predetermined value to the driver circuit 33a periodically at a predetermined ratio, for example and the present control flow ends.

Then, FIGS. 4A to 4D are a diagram illustrating a state of the PWM dimming of the light source driving device 3 according to the embodiment. FIG. 4A illustrates an example of an output pattern of the duty of step S23 illustrated in FIG. 3B, and FIGS. 4B to 4D illustrate an example of an output pattern of the duty of the step S24 illustrated in FIG. 3B.

FIG. 4A illustrates a state that an output signal of the duty of the predetermined value in step S23 illustrated in FIG. 3B is uniformly output with respect to a time axis. In this case, for example, the supply current amount supplied to the white LED 41a by the driver circuit 33a is an amount corresponding to the duty of the normally predetermined value. Then, the light intensity of the white LED 41a is maintained in a state of 100%, for example.

In contrast, FIG. 4B illustrates an output pattern of the duty in step S24 illustrated in FIG. 3B. As described above, in step S24 illustrated in FIG. 3B, for example, the duty of a predetermined value is thinning out periodically at predetermined ratio and then is output to the driver circuit 33a. Specifically, in FIGS. 4A and 4B, the duty is the same, but 3 ON-signals are consecutive and then a fourth ON-signal is omitted. Therefore, the pattern illustrated in FIG. 4B becomes a pattern of outputting the output signal of FIG. 4A periodically at a predetermined ratio. In this case, for example, the current supplied to the white LED 41a by the driver circuit 33a flows for time equivalent to only 75% time of the output of FIG. 4A. That is, the light intensity of the white LED 41a is dimmed to 75% of the output of the FIG. 4A, for example.

FIG. 4C illustrates an output pattern that another ON-signal is omitted from a state of FIG. 4B. Specifically, in FIGS. 4A and 4C, the duty is the same, but 2 ON-signals are consecutive and then a third and fourth ON-signals are omitted. Therefore, a pattern of FIG. 4C becomes a pattern of outputting the output signal of FIG. 4A periodically at a predetermined ratio. In this case, for example, the current supplied to the white LED 41a by the driver circuit 33a flows for time equivalent to only 50% time of the output of FIG. 4A. In other words, the light intensity of the white LED 41a is dimmed to 50% of the output of FIG. 4A, for example.

FIG. 4D illustrates an output pattern that another ON-signal is omitted from a state of FIG. 4C. Specifically, in FIGS. 4A and 4D, the duty is the same, but an ON signal is output and then second to fourth ON-signals are omitted. Therefore, a pattern of FIG. 4D becomes a pattern of outputting the output signal of FIG. 4A periodically at a predetermined ratio. In this case, for example, the current supplied to the white LED 41a by the driver circuit 33a flows for time equivalent to only 25% time of the output of FIG. 4A. In other words, the light intensity of the white LED 41a is dimmed to 25% of the output of FIG. 4A, for example.

As described above, according to the emission characteristics of the LED illumination device 4 illustrated in FIG. 2, the microcomputer 31 controls the output current of the driver circuit 33a by using PWM dimming. Therefore, it is possible to avoid an unstable light emission of the LED illumination device 4.

It is characterized that the light source driving device 3 according to the embodiment of the invention generates control information corresponding to each control level, by a calculation using a predetermined ratio calculation formula related to the dimming information Y and toning information X of the previously prepared dimming control and toning control.

In other words, since it is not necessary to prepare a memory area corresponding to the number of control levels, there is an effect that it is possible to reduce a memory capacity and a memory cost and to reduce a cost of controller (microcomputer 31).

In other words, according to an embodiment of the invention, even when the number of control levels of dimming or toning becomes larger, it is possible to provide a light source driving device and a dimming/toning control method that costs of memory and controller (microcomputer) cab be reduced.

The above-described embodiment has been described in detail for easy understanding of the invention, but is not limited to essentially having all of the configurations described above.

Further, it is possible to replace a part of the configuration of the embodiment with other configurations, and it is also possible to add some or all of the other configurations to the configuration of the embodiment.

Also, it is possible to add, delete and replace other configurations for some configurations of the embodiment.

Specifically, as a modification example of the embodiment of the invention, for example, there is the following (a) to (e).

(a) As described in FIGS. 1 and 4A to 4D, a case where the driver circuit 33a and the driver circuit 33b according to the embodiment controls an LED illumination device 4 using the PWM dimming has been described as an example. However, the dimming control method is not particularly limited thereto. The embodiments of the invention can be applied to a case of control using a method other than PWM dimming.

(b) In the embodiment, a case where two light sources (a white LED 41a and an orange LED 41b) are used as a LED illumination device 4 has been described as an example, but is not limited thereto. The embodiment of the invention can be applied to a light source driving device having three or more light sources.

(c) In the embodiment, for example, a case where the light source (for example, a white LED 41a and an orange LED 41b) is used as a LED illumination device 4 has been described as an example, but a color temperature is not particularly limited thereto.

(d) In the embodiment, the dimming indication signal and the toning indication signal has been described as a diming toning indication signal of DALI (registered trademark: Digital Addressable Lighting Interface). However, the diming indication signal and toning indication signal may be a dimming indication signal of ECHONET Lite (registered trademark). The ECHONET Lite (registered trademark) is a standard similar to DALI (registered trademark) and is a standard used for a control method of HEMS and BEMS. In other words, ECHONET Lite (registered trademark) is a standard that requires the number of control levels similar to DALI (registered trademark). Further, other standards besides these standards may be employed.

(e) In the embodiment, a kind of data stored in the ROM 32 (see FIG. 1) is not particularly limited. For example, a log curve corresponding to the DALI (registered trademark) may be stored in the ROM 32. For example, a log curve corresponding to the DALI (registered trademark) is stored in the ROM 32 and the dimming/toning indication signal can be output as a log curve rather than a linear curve. Thus, for example, even though a value of duty exceeds a predetermined value Dm or is smaller than the predetermined value Dm, it is possible to make the light intensity not changed abruptly. Particularly, in the case of using an LED illumination device 4 as the light source, since the LED has a fast reaction speed, when the duty becomes fine, in other words, the light is weakened, it may appear to emit dot light. However, desirably, when a log curve is stored in the ROM 32, such a situation is not caused.

In this case, between the steps S20 and step S21 in FIG. 3B, it is desirable that correction is performed using the log curve so that the control amount is to be a control amount between Dmin and Dmax.

According to the present invention, even when the number of control levels becomes larger, it is possible to provide a light source driving device and a dimming/toning control method which are capable of reducing a cost of a memory or a controller (microcomputer).

What is claimed is:

1. A light source driving device comprising:
a dimming/toning controller that receives a dimming indication signal and a toning indication signal for driving a plurality of light sources and calculates control information of each of the light sources based on the diming indication signal and the toning indication signal; and
a plurality of driving circuits that respectively drives each of the light sources according to each of the control information calculated by the dimming/toning controller.

2. The light source driving device according to claim 1,
wherein the dimming/toning controller proportionally divides a control amount according to the diming indication signal into each of the light sources at a rate based on a value of the toning indication signal.

3. The light source driving device according to claim 2,
wherein the dimming/toning controller calculates the control information by performing a linear transformation or a transformation using a log curve so that the control amount is within a range from a maximum control amount to a minimum control amount of each of the driving circuit.

4. The light source driving device according to claim 1,
wherein the dimming indication signal and the toning indication signal are a dimming/toning indication signal of Digital Addressable Lighting Interface (DALI) or ECHONET Lite.

5. A diming/toning control method to be executed by a light source driving device for driving a plurality of light sources, the method comprising:
receiving a dimming indication signal and a toning indication signal for driving a plurality of light sources;
calculating control information of each of the light sources based on the diming indication signal and the toning indication signal; and
driving each of the light sources according to each of the control information calculated by the dimming/toning controller.
